(19) United States
(12) Patent Application Publication
(10) Pub. No.: US 2023/0132868 A1
(43) Pub. Date: May 4, 2023

(54) INFORMATION PROCESSING APPARATUS, INFORMATION PROCESSING SYSTEM, NON-TRANSITORY COMPUTER READABLE MEDIUM STORING INFORMATION PROCESSING PROGRAM, AND INFORMATION PROCESSING METHOD

(71) Applicant: FUJIFILM Business Innovation Corp., Tokyo (JP)

(72) Inventor: Tomokazu YOSHIMURA, Kanagawa (JP)

(73) Assignee: FUJIFILM Business Innovation Corp., Tokyo (JP)

(21) Appl. No.: 17/827,785

(22) Filed: May 29, 2022

(30) Foreign Application Priority Data
Oct. 28, 2021 (JP) 2021-176771

(51) Int. Cl. G06Q 10/06; G06F 40/40

(52) U.S. Cl. CPC G06Q 10/0633; G06F 40/40; H04N 1/00244

(57) ABSTRACT

An information processing apparatus includes a processor configured to perform a process including presenting each step of a business flow including a plural steps registered in advance, receiving steps from start to end of a change of the business flow, as a change target, and changing the received change target, linking the changed change target to the business flow before the change, and registering the linked business flow as a new business flow.

### CROSS-REFERENCE TO RELATED APPLICATIONS

This application is based on and claims priority under 35 USC 119 from Japanese Patent Application No. 2021-176771 filed Oct. 28, 2021.

### BACKGROUND

### (i) Technical Field

The present invention relates to an information processing apparatus, an information processing system, a non-transitory computer readable medium storing an information processing program, and an information processing method.

### (ii) Related Art

JP2005-275745A proposes a business system having a workflow function such as examination and approval. The business system described in JP2005-275745A is provided with means for setting an environment by reading a text-based configuration file that defines design information on input and display items on an electronic document to be examined and approved.

### SUMMARY

In a case of using a text-based configuration file that defines design information on the input and display items on an electronic document, the screen configuration can be changed, but the business flow cannot be easily changed because the system itself needs to be recreated. It is considered the case where the business flow before the change is wanted to bed used, but in a case where the business flow is recreated from the system, the business flow before the change cannot be used. Considering versatility, it is desirable to make the business flow before the change available.

Aspects of non-limiting embodiments of the present disclosure relate to an information processing apparatus, an information processing system, a non-transitory computer readable medium storing an information processing program, and an information processing method that are capable of changing the business flow with versatility.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to perform a process including presenting each step of a business flow including a plurality of steps registered in advance, receiving steps from start to end of a change of the business flow, as a change target, and changing the received change target, linking the changed change target to the business flow before the change, and registering the linked business flow as a new business flow.

### BRIEF DESCRIPTION OF THE DRAWINGS

Exemplary embodiment(s) of the present invention will be described in detail based on the following figures, wherein:

FIG. 1 is a diagram illustrating a schematic configuration of an information processing system according to the present exemplary embodiment;

FIG. 2 is a block diagram showing a configuration of main parts of the electrical system of an image forming apparatus according to the present exemplary embodiment;

FIG. 3 is a block diagram showing a configuration of main parts of the electrical system of an information processing terminal and a cloud server according to the present exemplary embodiment;

FIG. 4 is a diagram showing an example of a form added by customization to an existing application form;

FIG. 5 is a diagram showing an example in which a to h steps are displayed as a business flow and c to e steps are received as change targets;

FIG. 6 is a diagram showing an example of a screen that receives contents of changed steps;

FIG. 7 is a diagram showing an example of a screen for confirming a checklist and a registered form;

FIG. 8 is a flowchart showing an example of a flow of a process performed in a case of customizing a business flow registered in advance, in a cloud server of the information processing system according to the exemplary embodiment;

and

FIG. 9 is a flowchart showing an example of a flow of a process performed in a case where each step of a business flow is executed, in the cloud server of the information processing system according to the present exemplary embodiment.

### DETAILED DESCRIPTION

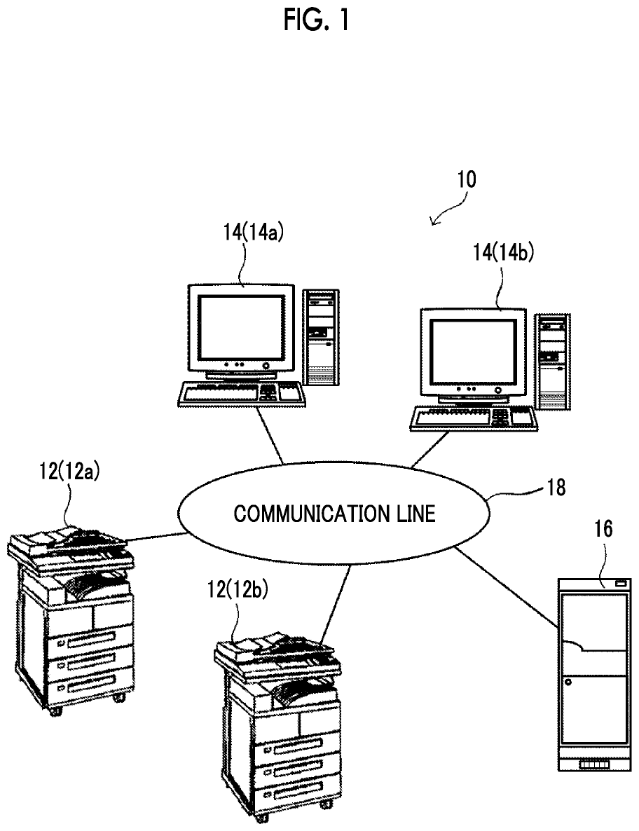

Hereinafter, an example of the present exemplary embodiment will be described in detail with reference to the drawings. In the present exemplary embodiment, an information processing system in which a plurality of image forming apparatuses, a plurality of information processing terminals, and a cloud server as an example of an information processing apparatus are connected to each other via a communication line such as a network will be described as an example. FIG. 1 is a diagram illustrating the schematic configuration of an information processing system 10 according to the present exemplary embodiment.

As shown in FIG. 1, the information processing system 10 according to the present exemplary embodiment includes a plurality of image forming apparatuses 12a, 12b, a plurality of information processing terminals 14a, 14b, . . . , and a cloud server 16. In a case where it is not necessary to distinguish between the image forming apparatuses 12a, 12b, . . . , and the information processing terminals 14a, 14b . . . , the alphabet at the end of the reference numeral may be omitted. Further, in the present exemplary embodiment, an example including a plurality of image forming apparatuses 12a, 12b, . . . , and a plurality of information processing terminals 14a, 14b, . . . , has been described, but one image forming apparatus 12 may be used.

Each image forming apparatus 12, the information processing terminal 14, and the cloud server 16 are connected to each other via a communication line 18 such as a Local Area Network (LAN), a Wide Area Network (WAN), the Internet, and an intranet. Each of the image forming apparatus 12, the information processing terminal 14, and the cloud server 16 can transmit and receive various data to and from each other via the communication line 18.

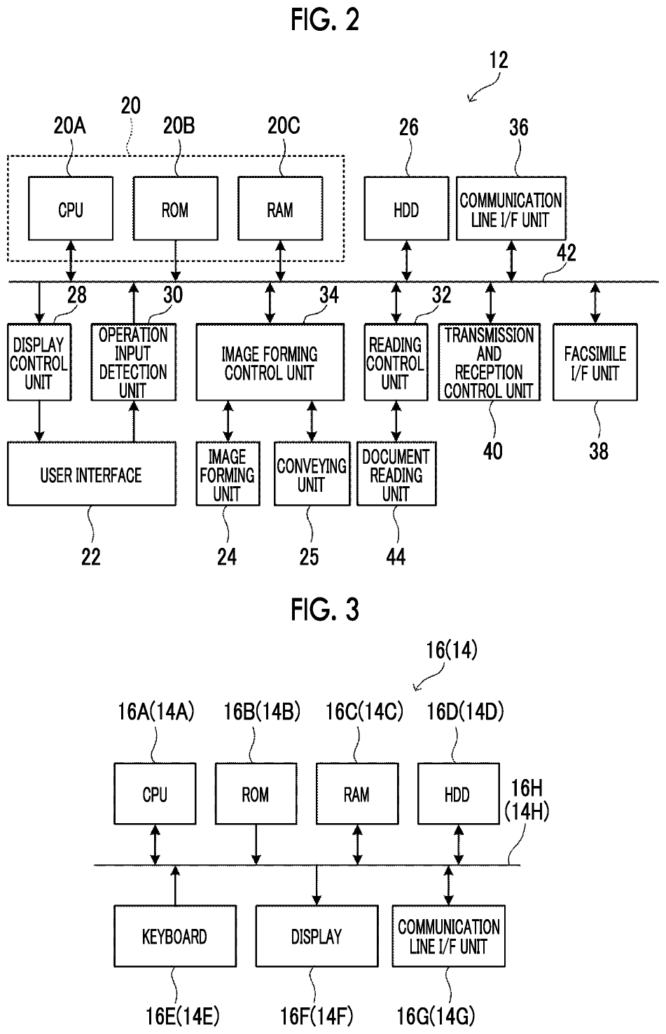

FIG. 2 is a block diagram showing the configuration of the main parts of the electrical system of the image forming apparatus 12 according to the present exemplary embodiment.

As shown in FIG. 3, the image forming apparatus 12 according to the present exemplary embodiment includes a control unit 20 including a central processing unit (CPU) 20A, a read only memory (ROM) 20B, and a random access memory (RAM) 20C. The CPU 20A controls the overall operation of the image forming apparatus 12. The RAM 20C is used as a work area or the like when executing various programs by the CPU 20A. Various control programs, various parameters, and the like are stored in advance in the ROM 20B. The image forming apparatus 12 is electrically connected to each part of the control unit 20 via a system bus 42.

On the other hand, the image forming apparatus 12 according to the present exemplary embodiment includes a hard disk drive (HDD) 26 for storing various data, application programs, and the like. Further, the image forming apparatus 12 includes a display control unit 28 that is connected to the user interface 22 and controls the display of various operation screens and the like on the display of the user interface 22. Further, the image forming apparatus 12 includes an operation input detection unit 30 that is connected to the user interface 22 and detects an operation instruction input via the user interface 22. In the image forming apparatus 12, the HDD 26, the display control unit 28, and the operation input detection unit 30 are electrically connected to the system bus 42. In the image forming apparatus 12 according to the present exemplary embodiment, the HDD 26 is applied as the storage unit, but the present invention is not limited to this, and a non-volatile storage unit such as a flash memory may be applied.

Further, the image forming apparatus 12 according to the present exemplary embodiment includes a reading control unit 32 that controls an optical image reading operation by the document reading unit 44 and a document feeding operation by the document conveying unit, and an image forming control unit 34 that controls an image forming process by the image forming unit 24, and conveying of paper to the image forming unit 24 by the conveying unit 25. Further, the image forming apparatus 12 is connected to the communication line 18 and has a communication line interface (I/F) unit 36 that transmits and receives communication data to and from another external apparatus such as the cloud server 16 connected to the communication line 18. Further, the image forming apparatus 12 includes a facsimile interface (I/F) unit 38 that is connected to a telephone line (not shown) and transmits and receives facsimile data to and from the facsimile apparatus connected to the telephone line. Further, the image forming apparatus 12 includes a transmission and reception control unit 40 that controls transmission and reception of facsimile data via the facsimile I/F unit 38. Then, in the image forming apparatus 12, the transmission and reception control unit 40, the reading control unit 32, the image forming control unit 34, the communication line I/F unit 36, the facsimile I/F unit 38, and the log collecting unit 46 are electrically connected to the system bus 42.

With the above configuration, the image forming apparatus 12 according to the present exemplary embodiment accesses the RAM 20C, the ROM 20B, and the HDD 26 by the CPU 20A, respectively. Further, the image forming apparatus 12 controls the display of information such as an operation screen and various messages on the display 22A of the user interface 22 via the display control unit 28, by the CPU 20A. Further, the image forming apparatus 12 controls the operations of the document reading unit 44 and the document conveying unit via the reading control unit 32, by the CPU 20A. Further, the image forming apparatus 12 controls the operations of the image forming unit 24 and the conveying unit 25 via the image forming control unit 34 and controls the transmission and reception of communication data via the communication line I/F unit 36, by the CPU 20A, respectively. Further, the image forming apparatus 12 controls the transmission and reception of facsimile data via the facsimile I/F unit 38 by the transmission and reception control unit 40, by the CPU 20A. Further, the image forming apparatus 12 grasps the operation contents in the user interface 22 based on the operation information detected by the operation input detection unit 30, and executes various controls based on the operation contents, by the CPU 20A.

Subsequently, the configuration of the main parts of the electrical system of the information processing terminal 14 and the cloud server 16 according to the present exemplary embodiment will be described. FIG. 3 is a block diagram showing the configuration of the main parts of the electrical system of the information processing terminal 14 and the cloud server 16 according to the present exemplary embodiment. Since the information processing terminal 14 and the cloud server 16 basically have a general computer configuration, the cloud server 16 will be described here as a representative.

As shown in FIG. 3, the cloud server 16 according to the present exemplary embodiment includes a CPU 16A, a ROM 16B, a RAM 16C, an HDD 16D, a keyboard 16E, a display 16F, and a communication line interface (I/F) unit 16G. The CPU 16A controls the overall operation of the cloud server 16. Various control programs, various parameters, and the like are stored in advance in the ROM 16B. The RAM 16C is used as a work area or the like when executing various programs by the CPU 16A. Various data, application programs, and the like are stored in the HDD 16D. The keyboard 16E is used to input various types of information. The display 16F is used to display various types of information. The communication line I/F unit 16G is connected to the communication line 18 and transmits and receives various data to and from other apparatuses connected to the communication line 18. Each part of the above cloud server 16 is electrically connected to each other via the system bus 16H. In the cloud server 16 according to the present exemplary embodiment, the HDD 16D is applied as a storage unit, but the present invention is not limited to this, and another non-volatile storage unit such as a flash memory may be applied.

With the above configuration, the cloud server 16 according to the present exemplary embodiment accesses the ROM 16B, the RAM 16C, and the HDD 16D by the CPU 16A, acquires various data through the keyboard 16E, and displays various types of information on the display 16F, respectively. Further, the cloud server 16 controls the transmission and reception of communication data via the communication line I/F unit 16G, by the CPU 16A.

In the information processing system 10 according to the present exemplary embodiment configured as described above, the cloud service provided by the cloud server 16 can be used from the information processing terminal 14. In the present exemplary embodiment, the cloud server 16 provides a cloud service that registers a business flow including a plurality of steps and executes the registered business flow. The business flow includes a plurality of steps such as application and approval, and performs a process by sequentially transmitting documents such as forms to the information processing terminal 14 or the like of the person in charge of each step.

Further, the cloud server 16 performs a process of customizing a business flow registered in advance and registering the customized business flow as a new business flow.

To customize the business flow, the cloud server 16 presents each step of the business flow registered in advance, and receives the step from the start to the end of the change of the business flow as the change target. Then, a process of changing the received change target, linking the changed change target to the business flow before the change, and registering the linked business flow as a new business flow is performed.

Here, customization of the business flow will be described by giving a specific example of the business flow as an example.

As an example of the business flow, a business flow including a plurality of the following steps a to h is registered in advance. For example, it is assumed that in the following business flow, benefits are applied for, as an example. The business flow is registered in the cloud server 16 by operating, for example, the information processing terminal 14. The business flow is not limited to the following, and other business flows may be applied.

a. Application reception process

b. Applicant's electronic stamp giving process

c. Application form circulation process

d. Application content check process by approver

e. Electronic stamp giving process by approver

f. Application approval process

g. Application result sending process

h. Application result confirmation process

Specifically, in “a. Application reception process”, the applicant creates an application form and registers the application form in the cloud server 16, and then the process proceeds to “b. Applicant's electronic stamp giving process” to give an electronic stamp to the application form registered in the cloud server 16. In a case where the electronic stamp is given to the application form registered in the cloud server 16, the process proceeds to “c. Application form circulation process” to transmit the application form, to which the electronic stamp is given, to the information processing terminal 14 of the person in charge who approves the application form, or notify that the application form has been registered, and then the process proceeds to “d. Application content check process by approver”. In a case where the approver checks the application form, the process proceeds to “e. Electronic stamp giving process by approver”, the approver operates the information processing terminal 14 to give an electronic stamp, register the electronic stamp in the cloud server 16, and subsequently transmit a notification to the information processing terminal 14 of the person in charge, and the process proceeds to “f. Application approval process”. In a case where the person in charge confirms the application approval content and registers the confirmation result in the cloud server 16, the process proceeds to “g. Application result sending process” to transmit the application result to the information processing terminal 14 of the applicant, or notify that the transmission result has been registered in the cloud server 16, and the process proceeds to “h. Application result confirmation process”. Then, in a case where the applicant confirms the application result, a series of business flows is ended.

In the following, it is found that the applicant can make a plurality of applications after starting the operation of the above business flow, so that an example of changing and customizing a part of the business flow will be described.

The department that receives application for benefits determines that a process of checking whether or not application by the identical applicant is possible and a process of cross-checking and giving an approval stamp by not only one approver but also a plurality of people (for example, a plurality of outsiders) are necessary, and considers trying to add and change the business flow as follows.

Process after Change

c. Application Form Circulation Process

(Additional flow 1) Application check process by the identical applicant

d. Application content check process by approver

e. Electronic stamp giving process by approver

(Additional Flow 2) Process of adding another manager as an approver, in addition to the existing approver, checking the application content, and giving an approval stamp

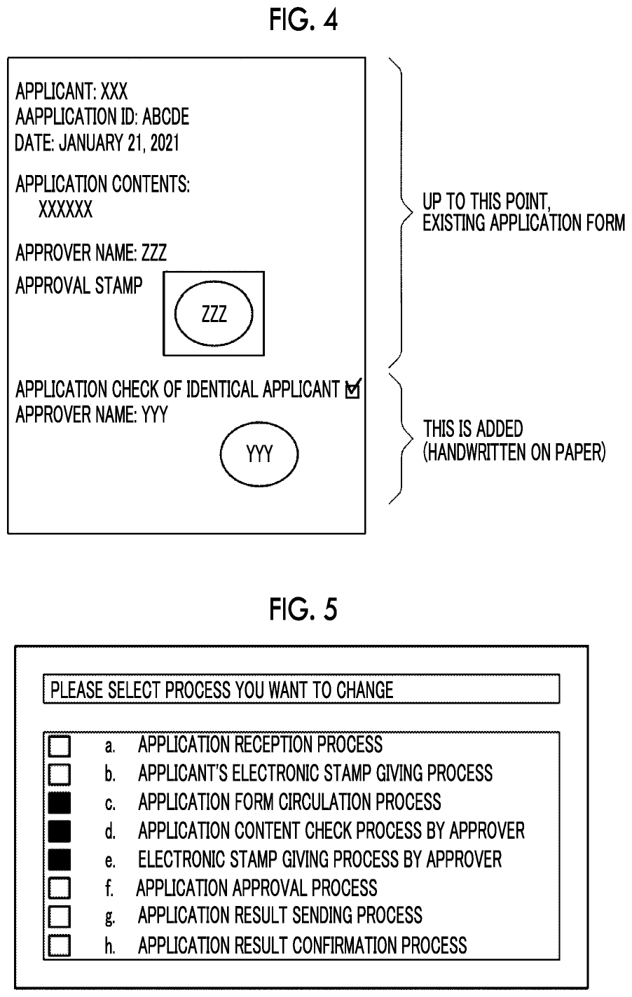

Due to the above changes, the business flow requires the following process but cannot respond to sudden changes. In particular, since it is not possible to respond to changes such as adding an external approver, the following steps are added to the c to e steps on a paper basis. Further, the checked stamps and the stamps of the approver are performed on a paper basis as shown in FIG. 2. FIG. 4 is a diagram showing an example of a form added by customizing an existing application form. In FIG. 4, although the form is shown as an example of adding by handwriting, original form data may be changed.

Additional Flow 1
Process of printing an application form
Process in which an applicant checks a database by himself and searches for other applications from the identical applicant
Process of writing in the application form that checking is completed, in a case where there is nothing else on a paper basis

Additional Flow 2
Process of receiving other managers' approval stamps as well as existing approval stamp on a paper basis

Based on the above, it is assumed that the steps c to e are newly registered as a changed process C′. However, since there is no problem other than the department that receives application for benefits, there is no problem with the existing business flow, so that the existing business flow is able to be used as before. Specifically, the representative of the department that receives application for benefits registers the processes of c to e as the changed process C′ in the case of the application process of receiving the benefits.

For example, as shown in FIG. 5, by transmitting and presenting each step of the business flow to the information processing terminal 14, the step is displayed on the display 14F and the contents of the step to be changed is received. In the example of FIG. 5, an example is shown in which steps a to h are displayed as a business flow and steps c to e are received as change targets as described above.

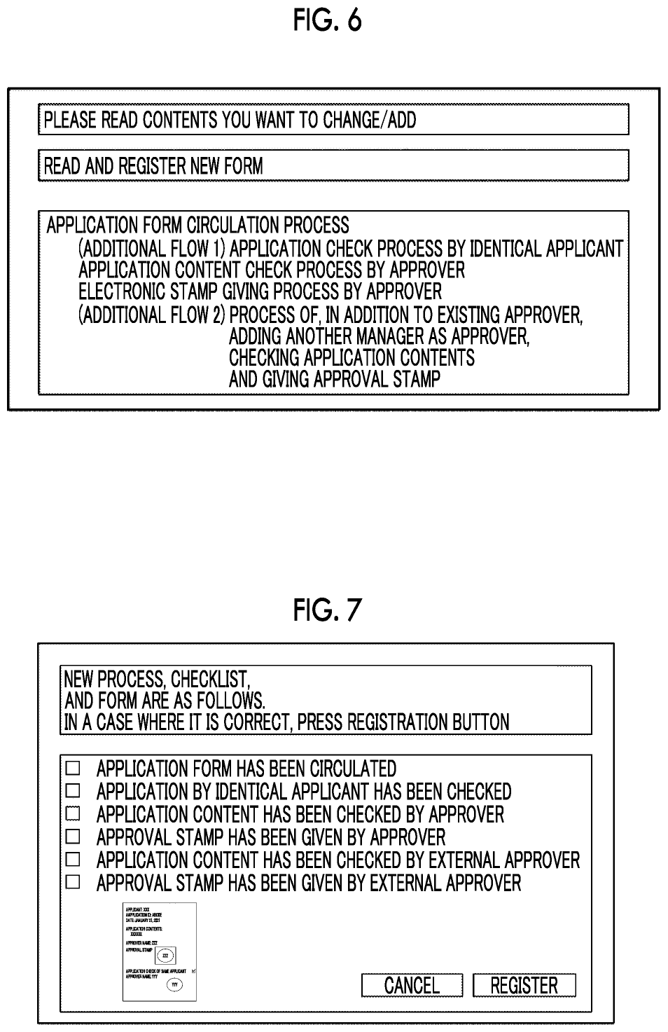

Further, as shown in FIG. 6, a changed process C′ is registered by receiving the input of the contents of the above-described changed steps. Specifically, by transmitting the contents of the changed steps input by the keyboard 14E or the like from the information processing terminal 14 to the cloud server 16, the cloud server 16 receives the contents of the changed steps. Further, the new form as shown in FIG. 4 is read by the image forming apparatus 12 or the like and registered in the cloud server 16.

In this case, by describing the process after change in natural language and registering the changed process in the business flow, the registered contents are analyzed and a natural language process performed to create and display a checklist corresponding to the registered changed process C′. As shown in FIG. 7, examples of the check items of the checklist in the above-described changed process C′ include “Application form has been circulated”, “Application by the identical applicant has been checked”, and “Application content has been checked by approver”, “Approval stamp has been given by approver”, “Application content has been checked by external approver”, and “Approval stamp has been given by external approver”.

Further, a process of linking the created checklist with the subsequent “f. Application approval process” is performed. Then, as shown in FIG. 7, a screen for confirming the checklist and the registered form is displayed, and in a case where there is no problem, the registration is completed. In the present exemplary embodiment, the changed process C′ is linked to the original business flow of a to h, and registered as a new business flow. In a case of linking the changed process C′ to the original business flow, and registering as a new business flow, a purpose, a person in charge, and a date may be included.

In a case of receiving benefits in using the registered business flow, it is possible to select changed process C′.

In a case where the applicant of the department receiving the benefit executes the business flow and reaches the process of “c. Application form circulation process”, the changed process C′ is listed on the screen. Here, as necessary, the changed process C′ is selected. On the other hand, in a case where the applicant of the unrelated department or the changed process C′ is unnecessary, the existing process is continued to be used.

In a case where the changed process C′ is selected, “e. Electronic stamp giving process by approver” is completed, and the process proceeds to the input waiting state of the checklist for proceeding to “f. Application approval process”.

In a case where the changed process C′ is selected, the image forming apparatus 12 outputs a checklist and an application form.

The applicant continues the changed process C′ according to the output application form and checklist.

In a case where the changed process C′ is completed and checking is given to the checklist, the checklist is read by the image forming apparatus 12 together with the application form and registered in the business flow.

The sent application form and checklist are confirmed, and in a case where there is no problem, the process proceeds to “f. Application approval process.”

Subsequently, a specific process performed by the cloud server 16 of the information processing system 10 according to the present exemplary embodiment will be described.

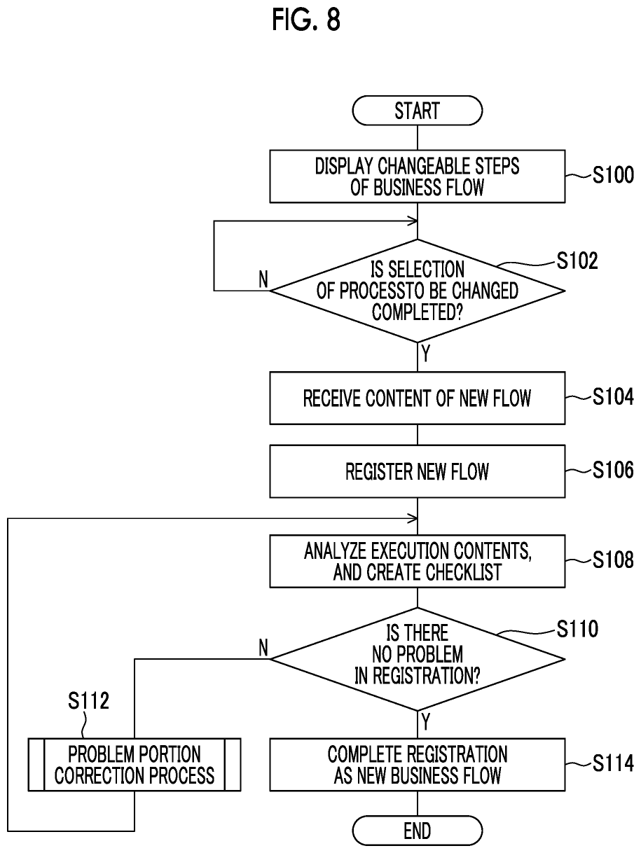

First, a specific process performed by the cloud server 16 in a case of customizing a business flow registered in advance will be described. FIG. 8 is a flowchart showing an example of a flow of a process performed in a case of customizing a business flow registered in advance, in the cloud server 16 of the information processing system 10 according to the present exemplary embodiment. The process of FIG. 8 is started, for example, in a case where the business flow to be changed is selected by the information processing terminal 14 and the execution of customization is instructed.

In step S100, the CPU 16A displays changeable steps of the business flow, and proceeds to step S102. For example, as shown in FIG. 5, by presenting the information processing terminal 14 with a screen for displaying each step of the business flow and selecting the step to be changed, the information processing terminal 14 receives the presentation from the cloud server 16, and displays the screen on the display 14F.

In step S102, the CPU 16A determines whether or not the selection of the step to be changed is ended. In the determination, the step to be changed is selected, and it is determined whether or not the operation indicating the end of selection is performed by the information processing terminal 14. The process proceeds to step S104 after waiting until the determination is positive.

In step S104, the CPU 16A receives the content of a new flow and proceeds to step S106. The change target and change contents of the business flow transmitted from the information processing terminal 14 are received. For example, as shown in FIG. 6, the input of the contents of the changed steps is received for the selected change target.

In step S106, the CPU 16A registers a new flow and proceeds to step S108. For example, as described above, the changed process C′ is registered.

In step S108, the CPU 16A analyzes the execution contents, creates a checklist, and proceeds to step S110. For example, by analyzing the execution content of the registered new flow and performing a natural language process, a checklist corresponding to the registered changed process C′ is created and presented to the information processing terminal 14, thereby displaying a checklist on the display 14F. For example, as shown in FIG. 7, a confirmation screen of a checklist and a read form is displayed. Here, correction on the created checklist may be received. The user may create the checklist by operating the information processing terminal 14.

In step S110, the CPU 16A determines whether or not there is no problem in registration. The determination determines, for example, whether or not the “registration” on the confirmation screen of FIG. 7 has been operated. In a case where the determination is negative, the process proceeds to step S112, and in a case where the determination is positive, the process proceeds to step S114.

In step S112, the CPU 16A performs a problem part correction process, returns to step S108, and repeats the above process. In the problem part correction process, the process of receiving the correction of the problem part and re-registering the new flow is performed.

In step S114, the CPU 16A completes registration as a new business flow and ends a series of processes. In a case of registering a new business flow, for example, the changed process C′ is linked to the original business flow a to h, and registered as a new business flow.

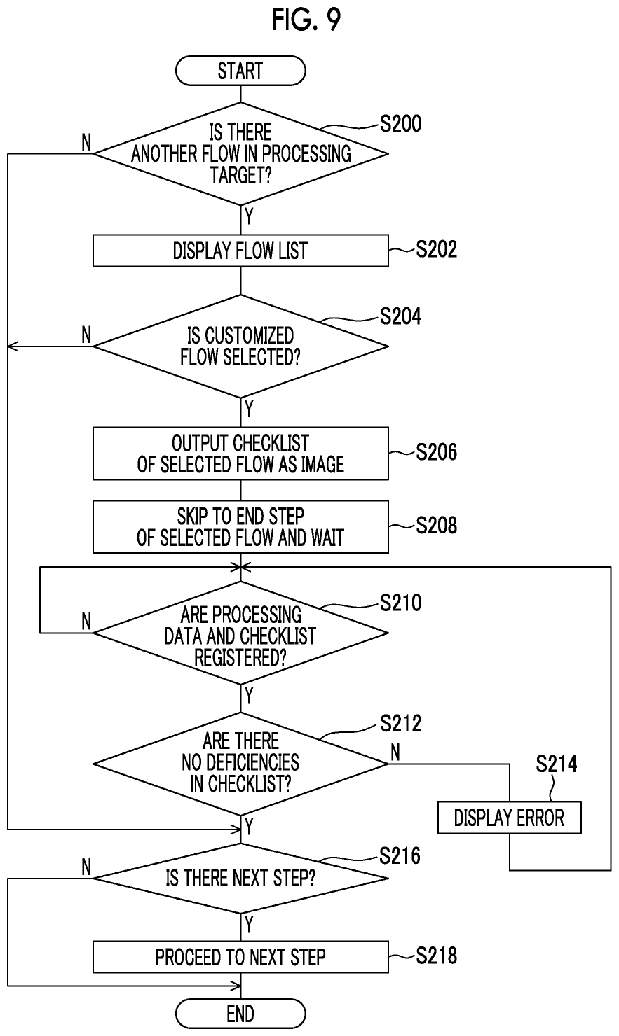

Subsequently, a specific process performed by the cloud server 16 in a case of executing each step of the business flow will be described. FIG. 9 is a flowchart showing an example of a flow of a process performed in a case where each step of a business flow is executed, in the cloud server 16 of the information processing system 10 according to the present exemplary embodiment. The process of FIG. 9 is performed in a case where each step of the business flow is executed.

In step S200, the CPU 16A determines whether or not there is another flow in the processing target. In the determination, it is determined whether or not the step to be processed has a customized and registered business flow. In a case where the determination is positive, the process proceeds to step S202, and in a case where the determination is negative, the process proceeds to step S216.

In step S202, the CPU 16A displays the flow list and proceeds to step S204. That is, in a case where a plurality of business flows, which are linked to the business flow in execution and registered, are registered, the flow list is presented to the information processing terminal 14 and the flow list is displayed on the display 14F.

In step S204, the CPU 16A determines whether or not the customized flow is selected. The determination is made based on the selection result received from the information processing terminal 14. For example, it is determined whether or not the business flow, that is customized and registered through the process of FIG. 8, is selected. In a case where the determination is positive, the process proceeds to step S206, and in a case where the original flow is selected and the determination is negative, the process proceeds to step S216. In step S204, a customized business flow may be selected according to user information such as the department to which the user belongs, and it may be determined whether or not the customized business flow is selected.

In step S206, the CPU 16A outputs a checklist of the selected flow as an image and proceeds to step S208. That is, in a case where there is a checklist created in step S108 described above, the checklist is transmitted to the image forming apparatus 12 registered in advance corresponding to the user and an image is formed. The checklist may be transmitted to the information processing terminal 14 to instruct the information processing terminal 14 to form an image, and the user may instruct the image forming apparatus 12 to form an image.

In step S208, the CPU 16A skips to the end step of the selected flow, waits, and proceeds to step S210.

In step S210, the CPU 16A determines whether or not the processing data and the checklist have been registered. That is, it is determined whether or not the processing data such as the processing form stamped as shown in FIG. 4 of the customized and added step and the checked checklist are read and registered by the image forming apparatus 12. In a case where the reading result of the image forming apparatus 12 is received and registered, the determination is positive, and the process proceeds to step S212 after waiting until the determination is positive.

In step S212, the CPU 16A determines whether or not there are no deficiencies in the checklist. The determination may be made, for example, by registering the presence or absence of deficiencies in a case of registering the checklist. Alternatively, the presence or absence of deficiencies may be determined by determining the presence or absence of a stamp in the stamp column of FIG. 4 through image analysis. In a case where the determination is negative, the process proceeds to step S214, and in a case where the determination is positive, the process proceeds to step S216.

In step S214, the CPU 16A displays an error, returns to step S210, and repeats the above process. For example, by presenting an error to the information processing terminal 14, the error is displayed on the display 14F of the information processing terminal 14, and the proceeding to the next step is prohibited.

In step S216, the CPU 16A determines whether or not there is a next step. In a case where the determination is positive, the process proceeds to step S218, and in a case where the determination is negative, a series of processes is ended.

In step S218, the CPU 16A proceeds to the next step of the business flow and ends a series of processes.

In the above exemplary embodiment, the process of FIGS. 8 and 9 has been described as the process performed by the cloud server 16, but the present invention is not limited to this. For example, a part of the process may be performed by the information processing terminal 14.

In the embodiments above, the term “processor” refers to hardware in a broad sense. Examples of the processor include general processors (e.g., CPU: Central Processing Unit) and dedicated processors (e.g., GPU: Graphics

Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

Further, the process performed by the cloud server 16 according to the above exemplary embodiment may be a process performed by software, a process performed by hardware, or a combination of both. Further, the process performed by the cloud server 16 may be stored in a storage medium as a program and distributed.

Further, the present invention is not limited to the above, and it goes without saying that the present invention can be variously modified and implemented within a range not deviating from the gist thereof.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to perform a process including:
presenting each step of a business flow including a plurality of steps registered in advance;
receiving steps from start to end of a change of the business flow, as a change target; and
changing the received change target, linking the changed change target to the business flow before the change, and registering the linked business flow as a new business flow.

2. The information processing apparatus according to claim 1, wherein the processor is configured to:
include a purpose, a person in charge, and a date in the new business flow in the registration.

3. The information processing apparatus according to claim 1, wherein the processor is configured to:
further perform a process of generating a checklist from a change result of the change target by using a natural language process.

4. The information processing apparatus according to claim 2, wherein the processor is configured to:
further perform a process of generating a checklist from a change result of the change target by using a natural language process.

5. The information processing apparatus according to claim 1, wherein the processor is configured to:
perform a process of displaying a list and receiving a selection result, in a case where a plurality of the business flows in which the change target is changed are registered, in executing the business flow.

6. The information processing apparatus according to claim 2, wherein the processor is configured to:
perform a process of displaying a list and receiving a selection result, in a case where a plurality of the business flows in which the change target is changed are registered, in executing the business flow.

7. The information processing apparatus according to claim 3, wherein the processor is configured to:
perform a process of displaying a list and receiving a selection result, in a case where a plurality of the business flows in which the change target is changed are registered, in executing the business flow.

8. The information processing apparatus according to claim 4, wherein the processor is configured to:
perform a process of displaying a list and receiving a selection result, in a case where a plurality of the business flows in which the change target is changed are registered, in executing the business flow.

9. The information processing apparatus according to claim 1, wherein the processor is configured to:
select the business flow corresponding to user information, in a case where a plurality of the business flows in which the change target is changed are registered, in executing the business flow.

10. The information processing apparatus according to claim 2, wherein the processor is configured to:
select the business flow corresponding to user information, in a case where a plurality of the business flows in which the change target is changed are registered, in executing the business flow.

11. The information processing apparatus according to claim 3, wherein the processor is configured to:
select the business flow corresponding to user information, in a case where a plurality of the business flows in which the change target is changed are registered, in executing the business flow.

12. The information processing apparatus according to claim 4, wherein the processor is configured to:
select the business flow corresponding to user information, in a case where a plurality of the business flows in which the change target is changed are registered, in executing the business flow.

13. The information processing apparatus according to claim 5, wherein the processor is configured to:
perform a process of forming an image of a checklist corresponding to the selected business flow.

14. The information processing apparatus according to claim 1, wherein the processor is configured to:
skip the steps before the change until the end of the change target and waits for input of a checklist, in a case of executing the business flow in which the change target is changed.

15. The information processing apparatus according to claim 1, wherein the processor is configured to:
perform a process of receiving and registering processed data and a reading result of a checklist in the business flow, in a case of executing the business flow in which the change target is changed.

16. The information processing apparatus according to claim 15, wherein the processor is configured to:
prohibit proceeding to a next step, in a case where there are deficiencies in the received checklist.

17. The information processing apparatus according to claim 15, wherein the processor is configured to:
perform a process of displaying an error, in a case where there are deficiencies in the received checklist.

18. An information processing system comprising:
the information processing apparatus according to claim 1; and
an information processing terminal that receives presentation of each step of the business flow from the information processing apparatus, displays presentation contents, and transmits the change target and change contents to the information processing apparatus.

19. A non-transitory computer readable medium storing an information processing program causing a computer to execute a process comprising:
presenting each step of a business flow including a plurality of steps registered in advance;
receiving steps from start to end of a change of the business flow, as a change target; and
changing the received change target, linking the changed change target to the business flow before the change, and registering the linked business flow as a new business flow.

20. An information processing method comprising:
presenting each step of a business flow including a plurality of steps registered in advance;
receiving steps from start to end of a change of the business flow, as a change target; and
changing the received change target, linking the changed change target to the business flow before the change, and registering the linked business flow as a new business flow.
